(19) United States
(12) Patent Application Publication
(10) Pub. No.: US 2009/0073813 A1
(43) Pub. Date: Mar. 19, 2009

(54) ALARM CLOCK WITH MULTIPLE INTERACTIVE AUDIO NOTIFICATIONS

(76) Inventor: Thomas Stephens, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 12/210,905

(22) Filed: Sep. 15, 2008

Related U.S. Application Data
(60) Provisional application No. 60/972,066, filed on Sep. 13, 2007.

(51) Int. Cl. G04C 21/00

(52) U.S. Cl. 368/73

(57) ABSTRACT

An alarm clock assembly includes a time mechanism for keeping current time, a display for displaying the current time, an input device for receiving an alarm time from a user, and an audio output device. An alarm mechanism is configured for playing a first audible alarm over the audio output device in response to the current time being equal to the alarm time. A snooze mechanism having a snooze input for receiving a snooze command from the user, the snooze mechanism being configured for temporarily ceasing the playing of the first audible alarm by the alarm mechanism. An alarm off mechanism having an input for receiving an off command from a user and for terminating the playing of the first audible alarm and for playing a second audible alarm over the audio output in response to receiving the off command. The assembly can also be configured for enabling the user to customize and/or record alarms such as audio clips as the first and/or second audible alarms and can be configured for playing a third audible alarm in response to receiving a snooze command.

### CROSS-REFERENCE TO RELATED APPLICATIONS

This application claims priority to the provisional application Ser. No. 60/972,066 filed Sep. 13, 2007 and is incorporated herein by reference

### FIELD OF THE DISCLOSURE

The present disclosure relates to alarm clocks and, more specifically, to an alarm clock with user customizable alarms.

### BACKGROUND

The statements in this section merely provide background information related to the present disclosure and may not constitute prior art.

Alarm clocks are well known. However, typical alarm clocks are not customizable by the user and do not lend themselves as novelty items or as sports memorabilia except to the extent of their aesthetics including coloring and graphics.

Additionally, existing alarm clocks include a snooze button that temporarily halts an alarm. However, these snooze buttons are not customizable and do not provide a user interaction that would benefit the waking up of the user.

### BRIEF SUMMARY OF THE INVENTION

The inventor hereof has succeeded at designing a new and improved alarm clock assembly. Various embodiments of the alarm clock assembly as described herein can provide for improved user enjoyment through customizing of alarms to the interest of the user. Additionally, in some embodiments the users use and acceptance of the alarm clock is improved through the playing of an alarm or pre-recorded audio clip interactively in response to the user activating the snooze or alarm off mechanisms following one or more alarm notifications.

According to one aspect, an alarm clock assembly includes a time mechanism for keeping current time, a display for displaying the current time, an input device for receiving an alarm time from a user, and an audio output device. An alarm mechanism is configured for playing a first audible alarm over the audio output device in response to the current time being equal to the alarm time. A snooze mechanism has a snooze input for receiving a snooze command from the user and is configured for temporarily ceasing the playing of the first audible alarm by the alarm mechanism. An alarm off mechanism has an input for receiving an off command from the user and is configured for playing a second audible alarm over the audio output in response to receiving the off command.

According to another aspect, an alarm clock assembly having a display for displaying the time, an input device for receiving an alarm time as input by a user, a time mechanism for keeping current time, and an audio output, includes a first memory for storing a first pre-recorded audio clip, a second memory for storing a second pre-recorded audio clip, a third memory for storing a third pre-recorded audio clip, an alarm mechanism configured for playing the first pre-recorded audio clip over the audio output in response to the current time being equal to the alarm time or the lapsing of a snooze time, a snooze mechanism having an input for receiving a snooze command from a user and for temporarily ceasing the playing of the first pre-recorded audio clip by the alarm mechanism upon receipt of a snooze command, the snooze mechanism being further configured for playing back the second pre-recorded audio clip over the audio output in response to receiving the snooze command, and an alarm off mechanism having a user input for receiving an off command and being configured for terminating the playing of the first pre-recorded audio clip and playing the third pre-recorded audio clip, each in response to receiving an off command.

According to yet another aspect, an alarm clock assembly having a display for displaying the time, an input device for receiving an alarm time from a user, a time mechanism for keeping current time, and an audio output, includes a first memory for storing a first pre-recorded audio clip, a second memory for storing a second pre-recorded audio clip, and a third memory for storing a third pre-recorded audio clip. A snooze mechanism has an input for receiving a command from a user. An alarm mechanism is configured for playing the first pre-recorded audio clip over the audio output in response to the current time being equal to the alarm time and for playing the third pre-recorded audio clip over the audio output in response to a lapse of a predetermined period of time as determined by the time mechanism following the user providing the input to the snooze mechanism, wherein the snooze mechanism is configured for temporarily ceasing the playing of the first pre-recorded audio clip by the alarm mechanism upon receipt of such user command and for playing back the second pre-recorded audio clip over the audio output in response to receiving the user command.

According to still another aspect, an alarm clock assembly having a display for displaying the time, an input device for receiving an alarm time from a user, a time mechanism for keeping current time, and an audio output, includes a first memory for storing a first pre-recorded audio clip and a second memory for storing a second pre-recorded audio clip. A snooze mechanism has an input for receiving a command from a user. An alarm mechanism is configured for playing the first pre-recorded audio clip over the audio output in response to the current time being equal to the alarm time and for playing an alarm signal over the audio output in response to a lapse of a predetermined period of time as determined by the time mechanism following the user providing the input to the snooze mechanism. The snooze mechanism is also configured for temporarily ceasing the playing of the first pre-recorded audio clip by the alarm mechanism upon receipt of such user command and for playing back the second pre-recorded audio clip over the audio output in response to receiving the user command.

Further aspects of the present disclosure will be in part apparent and in part pointed out below. It should be understood that various aspects of the disclosure may be implemented individually or in combination with one another. It should also be understood that the detailed description and drawings, while indicating certain exemplary embodiments, are intended for purposes of illustration only and should not be construed as limiting the scope of the disclosure.

### BRIEF DESCRIPTION OF THE DRAWINGS

FIG. 1 is a front perspective view of an alarm clock assembly according to one exemplary embodiment.

FIG. 2 is a block diagram of various components of an alarm clock assembly according to some exemplary embodiments.

FIG. 3 is a block diagram of an exemplary control system suitable for use with the alarm clock assembly of the present disclosure.

It should be understood that throughout the drawings, corresponding reference numerals indicate like or corresponding parts and features.

### DESCRIPTION

The following description is merely exemplary in nature and is not intended to limit the present disclosure or the disclosure's applications or uses.

Before turning to the figures and the various exemplary embodiments illustrated therein, a detailed overview of various embodiments and aspects is provided for purposes of breadth of scope, context, clarity, and completeness.

In some embodiments, an alarm clock assembly includes a time mechanism for keeping current time, a display for displaying the current time, an input device for receiving an alarm time from a user, and an audio output device such as a speaker. An alarm mechanism is configured for playing a first audible alarm over the audio output device in response to the current time being equal to the alarm time. A snooze mechanism having a snooze input for receiving a command from the user, the snooze mechanism being configured for temporarily ceasing the playing of the first audible alarm by the alarm mechanism. An alarm off mechanism has an input for receiving an off command and is configured for terminating the playing of the first audible alarm and playing a second audible alarm over the audio output in response to receiving the user command.

Additionally, the snooze mechanism can be configured to play another or third audible alarm in response to receiving the snooze command.

Additionally, memories and input devices can be used for receiving and storing pre-recorded audio clips for the first and second audible alarms, as well as additional alarms. For example, a first memory can be used for storing a first pre-recorded audio clip and a second memory can be used for storing a second pre-recorded audio clip. In such embodiments, the alarm mechanism can be configured for playing the first pre-recorded audio clip over the audio output in response to the current time being equal to the alarm time. The snooze mechanism can be configured for temporarily ceasing the playing of the first pre-recorded audio clip and playing the second pre-recorded audio clip over the audio output, each in response to receiving the user command. As noted additional memory can be included for storing additional pre-recorded audio clips and the alarm clock can be configured for playing different pre-recorded clips following the first alarm and the first activation of the snooze mechanism by the user.

This can include playing a different pre-recorded audio clip in response to a lapse of a predetermined period of time following the user providing the input to the snooze mechanism

As is known in the art, the snooze mechanism can include a user input that is typically a bar or button, but can also be simply a placement of a hand on a housing of the alarm clock assembly.

In some embodiments, the pre-recorded audio clips can include a recording or text playback or music including a known announcer, celebrity, on-air personality, song or a simple alarm. The pre-recorded audio clips to be played can be the same for each instance or different. For example, the first alarm could include a playback of a first audio clip that includes a well-known announcer or phrase, such as for a baseball Cardinals fan playing an audio clip of Mike Shannon saying “Get up baby . . . . Get up!” one or more times, Or for a Chicago Cubs baseball fans, the first audio clip could include the playing of an audio clip of Harry Carey such as the 7th inning stretch, “Take me out to the ball game.” When the user hits the snooze button, that first audio clip can be temporarily ceased or in some embodiments a snooze audio clip can be played, such as the playing of a great moment in St. Louis Cardinal History or great moment in sports or another team. This will alternate and continue until the user hits the alarm off mechanism or input. When the alarm off is received, the first audio clip is terminated and another audio clip is played such as for St. Louis Cardinal fans, an audio clip of Jack Buck saying, “And thats a winner!” or a Cubs fan playing an audio clip of Harry Carey saying, “Holy Cow!” Of course these are only examples, using the St. Louis Cardinals and Chicago Cubs baseball announcers. One skilled in the art should understand by this disclosure that any other well known or popular grouping of audio clips for any sport, such as football, hockey, NASCAR, by ways of example, could also be used. Also, as discussed herein, the alarm clock can be configured to have a coordinated appearance with team colors or other logos.

Also as noted the pre-recorded audio or audible clips can be pre-recorded by the manufacturer to correspond to a theme of the alarm clock for example, a sports team, movie or television quotes or sayings, rock band, religion, politician, company or otherwise. In other embodiments, the alarm clock can include a user input that allows the user to record or input user specific audio clips for use as alarms such as from an external audio source or it can include a microphone in some embodiments.

As noted, the alarm clock assembly also includes a housing having a particular design for housing the various components of the assembly. In some embodiments as noted above, the housing can include a shape, color, emblem, or otherwise a theme that corresponds with the alarms and/or audio clips.

FIG. 1 illustrates one exemplary embodiment of an alarm clock assembly 100 of the present disclosure. As shown alarm clock assembly includes a display 102, an output 104 such as a speaker, one or more indicia 106, alarm off input mechanism 108 (shown as two various options), user inputs 110, a snooze input 112, a volume control 114, an input jack 116 or a microphone 118.

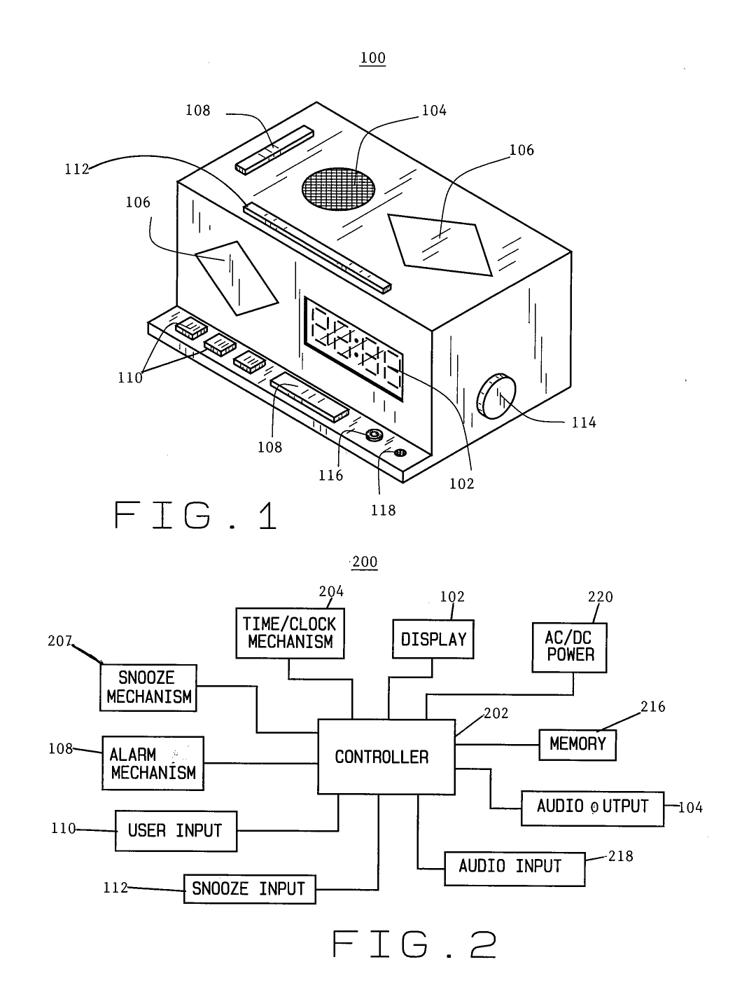

FIG. 2 illustrates a block diagram 200 of the various components of an exemplary embodiment of an alarm click assembly 100. As shown in FIG. 2, the clock assembly 100 as described above can include a controller 202 including an operational computer environment to perform one or more of the described functions such as all or a portion of a time/clock mechanism 204, an alarm mechanism 108 for controlling the playing of the audio clips or alarms, a snooze mechanism 207 including a snooze input 208 as well as controlling one or more of an audio output 104 and/or controlling the playing of the audio clips or alarms, a receiving user input 110, a display 102, a memory 216 for storing audio clips, an audio input 218 controlling the recording or reception of the user input audio clips, and, in some embodiments either permanent or temporary AC power, or DC power, e.g., shown by way of example as AC/DC Power 220.

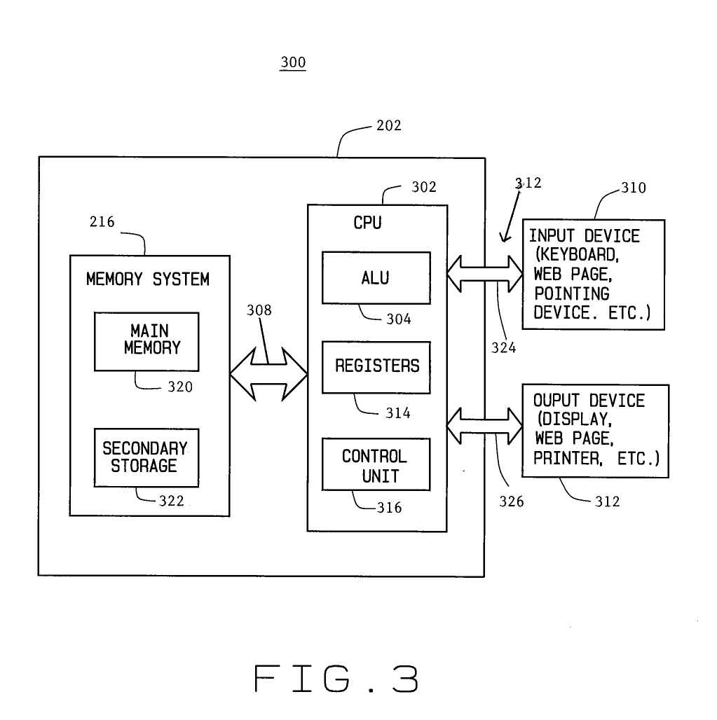

One exemplary operating environment for an alarm assembly 100 is illustrated in FIG. 3 and includes a computer system 300 with a computer/controller 202 that comprises at least one high speed processing unit (CPU) 302, in conjunction with a memory system 216 interconnected with at least one bus structure 308, an input device 310, and an output device 312. These elements are interconnected by at least one bus structure 312.

The illustrated CPU 302 is of familiar design and includes an arithmetic logic unit (ALU) 304 for performing computations, a collection of registers 314 for temporary storage of data and instructions, and a control unit 316 for controlling operation of the system 300. Any of a variety of processors, including at least those from Digital Equipment, Sun, MIPS, Motorola, NEC, Intel, Cyrix, AMD, HP, and Nexgen, are equally preferred for the CPU X. The illustrated embodiment of the invention operates on an operating system designed to be portable to any of these processing platforms.

The memory system 216 generally includes high-speed main memory 320 in the form of a medium such as random access memory (RAM) and read only memory (ROM) semiconductor devices, and secondary storage 322 in the form of long term storage mediums such as floppy disks, hard disks, tape, CD-ROM, flash memory, etc. and other devices that store data using electrical, magnetic, optical or other recording media. The main memory 320 also can include video display memory for displaying images through the display device 102. Those skilled in the art will recognize that the memory system 216 can comprise a variety of alternative components having a variety of storage capacities.

The input device 310 and output device 312 are also familiar and can be utilized for user input 110, snooze input 208, audio output 104 and audio input 218, by ways of examples and as applicable. The input device 310 can comprise a keyboard, a mouse, a physical transducer (e.g. a microphone), etc. and is interconnected to the computer 302 via an input interface 324. The output device 312 can comprise a display, a printer, a transducer (e.g. a speaker), etc, and be interconnected to the computer 302 via an output interface 326. Some devices, such as a network adapter or a modem, can be used as input and/or output devices.

As is familiar to those skilled in the art, the computer system 300 further includes an operating system and at least one application program. The operating system is the set of software that controls the computer system's operation and the allocation of resources. The application program is the set of software that performs a task desired by the user, using computer resources made available through the operating system. Both are resident in the illustrated memory system 216.

In accordance with the practices of persons skilled in the art of computer programming, the present invention is described below with reference to symbolic representations of operations that are performed by the computer system 300. Such operations are sometimes referred to as being computer-executed. It will be appreciated that the operations that are symbolically represented include the manipulation by the CPU 302 of electrical signals representing data bits and the maintenance of data bits at memory locations in the memory system 216, as well as other processing of signals. The memory locations where data bits are maintained are physical locations that have particular electrical, magnetic, or optical properties corresponding to the data bits. The invention can be implemented in a program or programs, comprising a series of instructions stored on a computer-readable medium. The computer-readable medium can be any of the devices, or a combination of the devices, described above in connection with the memory system 216.

It should be understood by those skilled in the art that the embodiments of FIGS. 1-3 are merely descriptive and exemplary and that other such embodiments are also within the scope of the description as described above and herein.

When describing elements or features and/or embodiments thereof, the articles “a”, “an”, “the”, and “said” are intended to mean that there are one or more of the elements or features. The terms “comprising”, “including”, and “having” are intended to be inclusive and mean that there may be additional elements or features beyond those specifically described.

Those skilled in the art will recognize that various changes can be made to the exemplary embodiments and implementations described above without departing from the scope of the disclosure. Accordingly, all matter contained in the above description or shown in the accompanying drawings should be interpreted as illustrative and not in a limiting sense.

It is further to be understood that the processes or steps described herein are not to be construed as necessarily requiring their performance in the particular order discussed or illustrated. It is also to be understood that additional or alternative processes or steps may be employed.

What is claimed is:

1. An alarm clock assembly having a display for displaying the time, an input device for receiving an alarm time from a user, a time mechanism for keeping current time, and an audio output, the clock comprising:
a first memory for storing a first pre-recorded audio clip;
a second memory for storing a second pre-recorded audio clip;
an alarm mechanism configured for playing the first pre-recorded audio clip over the audio output in response to the current time being equal to the alarm time;
a snooze mechanism having an input for receiving a snooze command from a user and for temporarily ceasing the playing of the first pre-recorded audio clip by the alarm mechanism upon receipt of a snooze command; and
an alarm off mechanism having an input for receiving an off command from a user and for terminating the playing of the first pre-recorded audio clip by the alarm mechanism and playing back the second pre-recorded audio clip over the audio output in response to receiving an off command.

2. The assembly of claim 1, further comprising a third memory for storing a third pre-recorded audio clip, wherein the snooze mechanism is configured for playing the third pre-recorded audio clip over the audio output in response receiving a user command on the snooze mechanism input.

3. The assembly of claim 2 wherein the first, second, and third pre-recorded audio clips are selected from the group of audio recordings consisting of an announcer, a celebrity, an on-air personality, a song, and an alarm.

4. The assembly of claim 3 wherein the each of the first, second, and third pre-recorded audio clips is different than another of the pre-recorded clips.

5. The assembly of claim 1, further comprising a third memory for storing a third pre-recorded audio clip, wherein the alarm mechanism is configured for playing the third pre-recorded audio clip over the audio output in response to a lapse of a predetermined period of time following the user providing the input to the snooze mechanism.

6. The assembly of claim 1 wherein the alarm mechanism is further configured for playing back an audible alarm over the audio output in response to a lapse of a predetermined period of time following the user providing the input to the snooze mechanism.

7. The assembly of claim 1 wherein the first and second pre-recorded audio clips are selected from the group of audio recordings consisting of an announcer, a celebrity, an on-air personality, a song, and an alarm.

8. The assembly of claim 7 wherein the second pre-recorded audio clip is different than the first pre-recorded clip.

9. The assembly of claim 1, further comprising a control unit configured for controlling the first memory, the second memory, the alarm mechanism and at least some of the functions of the snooze mechanism.

10. The clock of claim 1, further comprising an audio input configured for receiving the first and second pre-recorded audio clips from an external audio source.

11. The assembly of claim 1, further comprising a housing having a particular design, wherein the first pre-recorded audio clip and the second pre-recorded audio clip are each selected to correspond to the particular design of the housing.

12. The assembly of claim 11 wherein the housing is configured as a design associated with a particular sports team and wherein the first and second pre-recorded audio clips are audio recordings of one or more celebrities associated with the particular sports team.

13. The assembly of claim 12 wherein at least one of the celebrities is an announcer or an on-air personality.

14. The assembly of claim 1 wherein the alarm mechanism includes an input for receiving a user's request for terminating the playing of the first audio clip, further comprising a third memory for storing a third pre-recorded audio clip, wherein the alarm mechanism is configured for playing the third pre-recorded audio clip over the audio output in response to receiving a request to terminate the playing of the first audio clip.

15. An alarm clock assembly having a display for displaying the time, an input device for receiving an alarm time from a user, a time mechanism for keeping current time, and an audio output, the clock comprising:
a first memory for storing a first pre-recorded audio clip;
a second memory for storing a second pre-recorded audio clip;
a third memory for storing a third pre-recorded audio clip;
a snooze mechanism having an input for receiving a snooze command from a user and starting a snooze time period;
an alarm off mechanism having an input for receiving an off command from a user; and
an alarm mechanism configured for playing the first pre-recorded audio clip over the audio output in response to the current time being equal to the alarm time or the lapse of a snooze time period, wherein the snooze mechanism is configured for temporarily ceasing the playing of the first pre-recorded audio clip by the alarm mechanism upon receipt of a snooze command and for playing back the second pre-recorded audio clip over the audio output in response to receiving the snooze command, and wherein the alarm off mechanism is configured for terminating the playing of the first pre-recorded audio clip by the alarm mechanism and playing back the third pre-recorded audio clip over the audio output, each in response to receiving the off command.

16. The assembly of claim 15 wherein each of the first, second and third pre-recorded clips is selected from group consisting of an alarm, a song, a recording of a sports announcer, and a recording of an on-air personality.

17. The assembly of claim 16 wherein each of the first, second, and third pre-recorded clips is different.

18. An alarm clock assembly having a display for displaying the time, an input device for receiving an alarm time from a user, a time mechanism for keeping current time, and an audio output, the clock comprising:
a first memory for storing a first pre-recorded audio clip;
a second memory for storing a second pre-recorded audio clip;
a snooze mechanism having an input for receiving a snooze command from a user and for starting a snooze time;
an off mechanism for receiving an off command from a user; and
an alarm mechanism configured for playing the first pre-recorded audio clip over the audio output in response to the current time being equal to the alarm time or a lapse of the snooze time, wherein the snooze mechanism is configured for temporarily ceasing the playing of the first pre-recorded audio clip by the alarm mechanism upon receipt of a snooze command and for playing back the second pre-recorded audio clip over the audio output in response to receiving a snooze command.

19. The assembly of claim 18, further comprising a third memory for storing a third pre-recorded audio clip, wherein the off mechanism is configured for playing the third pre-recorded audio clip over the audio output in response to receiving an off command.

20. The assembly of claim 18 wherein each of the first and second pre-recorded clips is selected from group consisting of an alarm, a song, a recording of a sports announcer, and a recording of an on-air personality.
